(19) United States
(12) Patent Application Publication
(10) Pub. No.: US 2004/0041373 A1
(43) Pub. Date: Mar. 4, 2004

(54) Gas bag module and method for assembly of a gas bag module

(75) Inventors: Matthias Helmstetter, Aschaffenburg (DE); Michael Schneider, Niedemberg (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 10/645,242

(22) Filed: Aug. 21, 2003

(30) Foreign Application Priority Data
Aug. 27, 2002 (DE) 202 13 144.0

(51) Int. Cl. B60R 21/16

(52) U.S. Cl. 280/728.2

(57) ABSTRACT

In a gas bag module comprising a gas bag (16), a gas bag holding element (18) and a generator holder (12), the gas bag holding element (18) is fastened to the generator holder (12) by means of at least one drive screw (22).

### TECHNICAL FIELD

The invention relates to a gas bag module and to a method for mounting and disassembling a gas bag module.

### BACKGROUND OF THE INVENTION

Gas bag modules for drivers and passengers are now part of the regular equipment in many vehicles. Therefore, a need exists to manufacture such gas bag modules at as favourable a cost as possible. A time-consuming operating step is the assembling of the module and here, inter alia, the installation step in which the gas bag is connected by means of a gas bag holding element with a gas generator and/or with a generator holder or a module housing. This connection must be able to withstand high forces, so that the gas bag can not detach itself from the module during unfolding. A known, but work-intensive way consists in providing the gas bag holding element with threaded pins which are secured by nuts.

### BRIEF SUMMARY OF THE INVENTION

It is an object of the invention to provide a simple, quick and favourably-priced connection between a gas bag holding element and a generator holder or a module housing.

This is achieved in a gas bag module comprising a gas bag, a gas bag holding element and a generator holder. The gas bag holding element is fastened to the generator holder by means of at least one drive screw.

Drive screws are fastening means known from structural housing engineering. Drive screws unit features from nails and screws. A drive screw is formed in a way that it can be driven into a component with a purely translational force like a nail. Owing to the integrated thread, the drive screw can be detached by a rotational movement like a conventional screw. This offers the advantage that on the one hand the drive screw can be fastened quickly and securely by a brief, purely axial action of force, but on the other hand can be detached again like a conventional screw. The installation time is distinctly shorter than with a conventional screw connection. As no thread has to be provided on the gas bag holding element, the manufacturing costs of this component are reduced.

In this connection the term “drive screw” is meant to include also screw nails, in particular a screw nail according to DIN 68 163-A.

In the sense used here, the generator holder is the component on which the gas bag is secured by means of the gas bag holding element. The generator holder can also be constructed as a module housing and can thus at the same time hold the gas generator and the gas bag. In addition, the generator holder can be fastened directly to the vehicle or connected with the vehicle by means of further components.

Preferably, the gas bag holding element and the gas generator holder consist of plastic. The drive screw can likewise be made of plastic or metal.

Advantageously a drive screw is used which has a sawtooth profile which prevents the fastening being detachable by a traction in axial direction. In addition, the drive screw advantageously has a worked-in thread, so that it can be undone in the manner of a conventional screw.

In a preferred embodiment of the invention, the gas bag holding element has at least one expandable, sleeve-like extension to receive the drive screw, the sleeve-like extension being able to be expanded for example by at least one axial slit. The sleeve-like extension is advantageously spread apart radially by the drive screw, whereby a secure clamping of the sleeve-like extension in the generator holder can be achieved.

Advantageously, the sleeve-like extension has in addition a detent shoulder which comes into abutment against the generator holder. Especially in connection with the radial spreading of the sleeve-like extension, an axially-acting form-fitting connection with the generator holder can thus be achieved in a simple manner.

Preferably, an inner wall of the extension has at least one bead which is in engagement with the drive screw. This bead prevents the drive screw from being able to detach itself in the case of axial traction.

The proposed method for connecting the gas bag holding element with the generator holder can also be transferred to other connections, e.g. to installation of the gas generator holder on a vehicle. Here, also, the advantage of the drive screw can be used, namely that in a short time a secure connection is able to be produced which is detachable again in a simple manner.

It is a further object of the invention to provide a method with which a gas bag module can be easily assembled or mounted and disassembled. The method can be used for assembly of the single parts of a gas bag module as well as for mounting the complete gas bag module to the vehicle.

This object is achieved in that for assembling or mounting the gas bag module at least one drive screw provided with a thread is used. The drive screw is driven into two parts to be fixed at each other by a purely translational force. On disassembling the module the drive screw is detached from the parts by a rotational movement.

### BRIEF DESCRIPTION OF THE DRAWINGS

FIG. 1 shows a diagrammatic partial view, in section, of a gas bag module according to the invention, in which the parts are attached to each other by the method according to the invention;

FIG. 2 shows a diagrammatic perspective view of a gas bag holding element to use in a gas bag module according to the invention;

FIG. 3 shows the gas bag holding element of FIG. 2 viewed from its upper side;

FIG. 4 shows a top view onto the gas bag holding element of FIG. 3;

FIG. 5 shows a section along the line V-V in FIG. 4;

FIG. 6 shows an enlarged cut-out X from FIG. 5, which corresponds to a section along the line VI-VI in FIG. 4;

FIG. 7 shows a section along the line VII-VII in FIG. 6;

FIG. 8 shows an enlarged diagrammatic partial view of FIG. 1;

FIG. 9 shows a diagrammatic sectional view along the line IX-IX in FIG. 8;

FIG. 10 shows a part of a gas bag holding element of a gas bag module according to a further embodiment;

FIG. 11 shows a section along the line XI-XI of FIG. 10; and

FIG. 12 shows a section along the line XII-XII of FIG. 10.

### DETAILED DESCRIPTION OF A PREFERRED EMBODIMENT

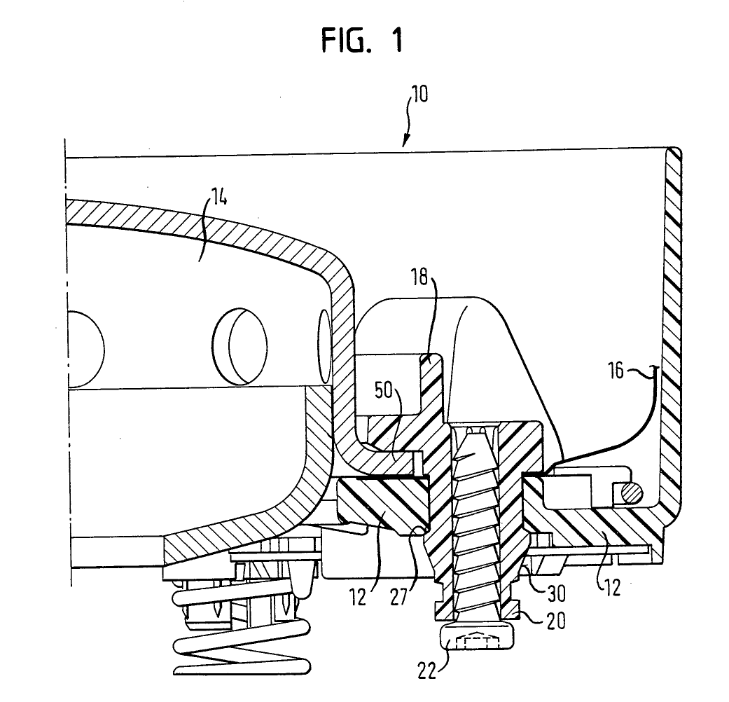

The gas bag module 10 illustrated in FIG. 1 has a generator holder 12 which in the example shown here is constructed as a module housing. A gas generator 14 and a gas bag 16 are fastened to the generator holder 12 by means of a gas bag holding element 18.

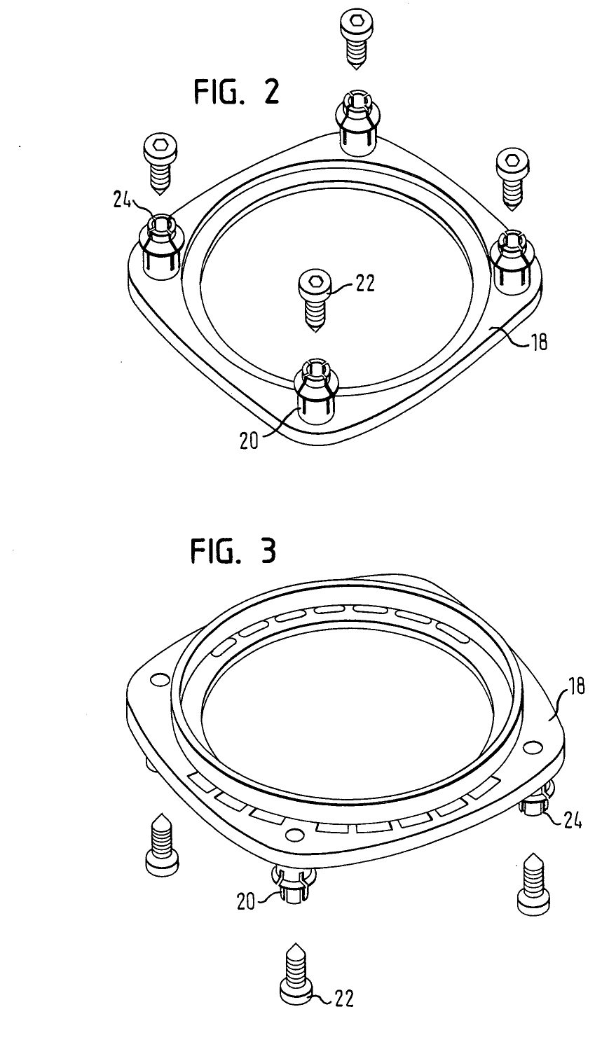

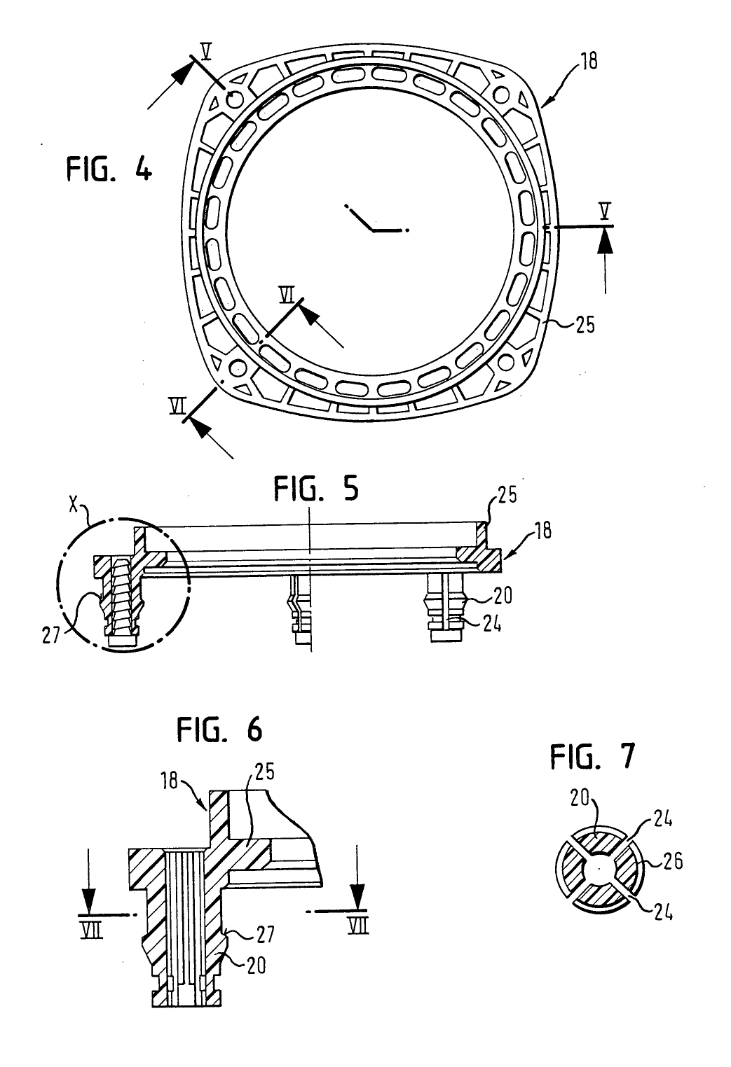

The gas bag holding element 18 is constructed in a ring shape and is inserted into an inflation opening of the gas bag 16. The gas bag holding element 18 has several sleeve-like extensions 20 formed on in one piece (see also FIGS. 2 to 7), which extend through openings in the gas bag 16 and in the generator holder 12. Drive screws 22 are introduced into these sleeve-like extensions 20, via which the gas bag holding element 18, the gas generator 14, the gas bag 16 and the generator holder 12 are firmly connected with each other.

In the head region, each drive screw 22 has an engagement structure formed e.g. as a protrusion or a depression. The engagement structure allows a transfer of a rotational movement to the drive screw 22 to disengage the drive screw 22 from the gas bag module 10, for instance with a tool like an Allan key or a crosstip screwdriver.

The gas bag holding element 18 is described in detail below. At the end directed away from the gas bag holding element 18, each sleeve-like extension 20 has axial slits 24. The slits 24 can extend up to the ring-shaped base body 25 of the gas bag holding element 18, so that the extension 20 is composed of several curved segments 26, four segments in the example shown here. On each segment 26 in addition a detent shoulder 27 is constructed, which comes into abutment against the generator holder 12 when the gas bag module 10 is assembled. Owing to the slits 24, the radial expansion of the sleeve-like extensions 20 can be reduced, so that in spite of the detent shoulders 27, a penetration of the extensions 20 through the openings of the generator holder 12 is possible. The detent shoulders 27 have chamfers 30 acting in the insertion direction, which facilitate the passage of the sleeve-like extensions 20 through the openings in the generator holder 12.

On introduction of the drive screw 22, the sleeve-like extension 20 is slightly widened in radial direction, so that the detent shoulders 27 engage behind the generator holder 12 and lie firmly against the generator holder 12, from which a form-fitting connection results in axial direction and, in addition, a secure clamping connection between the extensions 20 and the generator holder 12. During assembly the drive screw 22 is driven into the generator holder 12 and the extension 20 by a purely translational axial force.

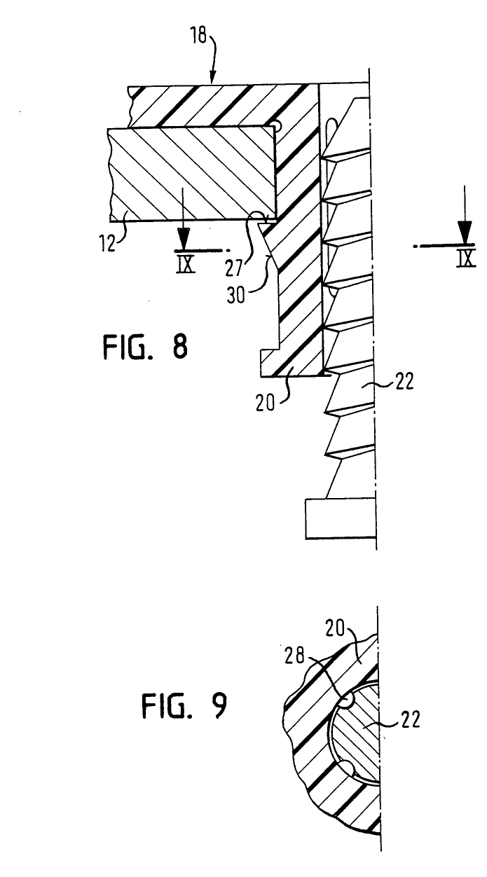

On the inner wall of the sleeve-like extensions 20, beads 28 are constructed, which can run in axial or peripheral direction (FIG. 9). The drive screw 22 has a thread with sawtooth profile, as can be seen in FIG. 8. The beads 28 engage into the sawtooth profile, whereby the drive screw 22 is additionally secured against detachment by axial traction.

The beads 28 act as a counter thread, so that the drive screw 22 can be detached like a normal screw.

The gas bag holding element 18 preferably consists of plastic and can advantageously be produced in one piece by injection moulding. Also, the generator holder 12 and the drive screw 22 can be produced from a suitable plastic, but can also consist of metal.

The installation of the gas bag module 10 takes place in a simple manner. The gas generator 14 is inserted into the generator holder 12 and the gas bag holding element 18 is inserted into the gas bag 16, and the sleeve-like extensions 20 of the gas bag holding element are inserted through the openings in the gas bag 16 and in the generator holder 12. Then the drive screws 22 are driven into the sleeve-like extensions 20 by a brief axial force action. For dismantling, the drive screws 22 merely have to be unscrewed from the sleeve-like extensions 20.

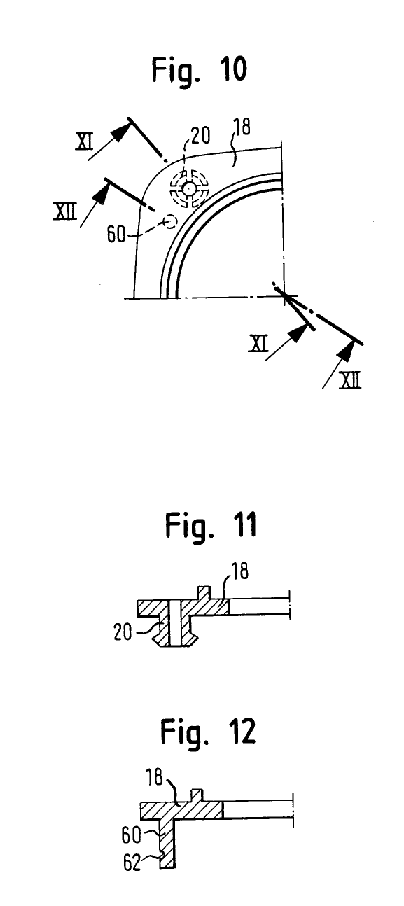

In the embodiment shown in FIGS. 10 to 12, the gas bag holding element 18 includes pins 60 formed integrally therewith, the pins 60 being provided additionally to the extensions 20 and arranged in the vicinity thereof. The pins 60 extend in the same direction as the extensions 20. On assembly of the gas bag module 10 the pins project through corresponding openings in the gas bag holding element 18 (not shown) and are engaged by an appropriate device (also not shown). To this account, each pin 60 is provided with a groove 62. By this arrangement, the axial force used for driving in the drive screw can be counteracted, so that the parts to be connected are not pressed apart. The pins 60 do not form a clip connection with the gas bag holding element 18. On disengagement of the drive screw 22 the pins 60 are simply pulled out of the gas bag holding element 18.

The gas bag module 10 can also be fastened to a vehicle by similarly constructed connections (not shown).

It is also to be stressed that the gas bag holding element 18 can be formed by the flange 50 of the gas generator 14, the flange 50 replacing the ring-shaped base body 25 of the gas bag holding element 18. In this embodiment, it would be possible to construct the sleeve-like extensions 20 as individual plastic pegs which engage into holes on the flange and project through the openings in the gas generator holder.

Instead of being provided on the gas bag holding element, the sleeve-like extensions 20 could also be provided on the generator holder 12 and project through openings in the flange 50 or in a separate gas bag holding element 18, the fastening taking place in an analogous manner to the embodiment described above.

1. A gas bag module comprising
a gas bag (16),
a gas bag holding element (18) and
a generator holder (12),
characterized in that said gas bag holding element (18) is fastened to said generator holder (12) by means of at least one drive screw (22).

2. The gas bag module according to claim 1, wherein said gas bag holding element (18) consists of plastic.

3. The gas bag module according claim 1, wherein said generator holder (12) consists of plastic.

4. The gas bag module according claim 1, wherein said drive screw (22) consists of plastic.

5. The gas bag module according to claim 1, wherein said drive screw (22) has a sawtooth profile.

6. The gas bag module according to claim 1, wherein said gas bag holding element (18) has at least one expandable sleeve-like extension (20) to receive a drive screw (22).

7. The gas bag module according to claim 6, wherein said sleeve-like extension (20) has at least one axial slit (24).

8. The gas bag module according to claim 6, wherein said sleeve-like extension (20) is radially spread apart by said drive screw (22).

9. The gas bag module according to claim 6, wherein said sleeve-like extension (20) has a detent shoulder (27) which lies against said generator holder (12).

10. The gas bag module according to claim 6, wherein on an inner wall of said extension (20) at least one bead (28) is constructed, which is in engagement with said drive screw (22).

11. A method for assembling and disassembling a gas bag module,
the gas bag module comprising a gas bag (16),
a gas bag holding element (18),
a generator holder (12),
characterized in that at least one drive screw provided with a thread is used,
the drive screw being driven by a purely translational force into two parts to be attached to each other and
on disassembly, the drive screw being detached from the parts by a rotational movement.

12. A method for mounting to and disassembling a gas bag module from a vehicle part,
the gas bag module comprising a gas bag (16),
a gas bag holding element (18),
a generator holder (12),
characterized in that at least one drive screw provided with a thread is used,
the drive screw being driven by a purely translational force into two parts to be attached to each other and
on disassembly, the drive screw being detached from the parts by a rotational movement.
